(19) United States
(12) Patent Application Publication
(10) Pub. No.: US 2016/0215205 A1
(43) Pub. Date: Jul. 28, 2016

(54) Enhancing Fracturing and Complex Fracturing Networks in Tight Formations

(71) Applicant: Halliburton Energy Services, Inc., Houston, TX (US)

(72) Inventors: Philip D. Nguyen, Houston, TX (US); Thomas Zachary Vonk, Houston, TX (US)

(73) Assignee: Halliburton Energy Services, Inc., Houston, TX (US)

(21) Appl. No.: 14/914,249

(22) PCT Filed: Sep. 23, 2013
(86) PCT No.: PCT/US13/61119

§ 371 Date: Feb. 24, 2016

(51) Int. Cl. C09K 8/80; E21B 43/26; E21B 43/267; C09K 8/62

(52) U.S. Cl. CPC C09K 8/80; C09K 8/62; E21B 43/26; E21B 43/267; C09K 2208/10; C09K 2208/28

(57) ABSTRACT

Methods of fracturing and, in certain embodiments, to methods of fracturing to enhance the communication between a primary fracture and its corresponding complex fracture network.

### BACKGROUND

The present method relates to fracturing treatments and, in certain embodiments, to methods of fracturing to enhance the communication between a primary fracture and its corresponding complex fracture network.

After a well bore is drilled, it may be necessary to fracture the subterranean formation to enhance hydrocarbon production. This may be of greater importance in shale formations that typically have high-closure stresses. Access to the subterranean formation can be achieved by first creating an access conduit from the well bore to the subterranean formation. Then a fracturing fluid, called a pad, may be introduced at pressures exceeding those required to maintain matrix flow in the formation to create or enhance at least one fracture that propagates from the well bore. The pad fluid may be followed by a fluid comprising a propping agent to prop the fracture or fractures open after the pressure is reduced. In some formations like shale, the primary fracture can further branch into other fractures; all extending through either a direct branch or indirect branch from the primary fracture and creating a complex fracture network. As used herein, a “complex fracture network” refers to a field or network of interconnecting fractures, which may include a primary fracture, secondary branch fractures, tertiary branch fractures, quaternary branch fractures, and the like. The complex fracture network encompasses the primary fracture and any and all branching fractures, regardless of their size, man-made or otherwise, within a subterranean formation that are in fluid communication with the access conduit and/or well bore. The propping agents hold the complex fracture network open, thereby maintaining the ability for hydrocarbons to flow through the complex fracture network to ultimately be produced at the surface.

Communication between the primary fracture and the remainder of the corresponding complex fracture network may be an important factor to maximizing production from the formation. Shale and other low permeability formations may be difficult to fracture and may require repeated fracturing attempts in order to create an adequate fracture network for the production of hydrocarbons. Without adequate fracturing of the formation, these formations may exhibit a steep production decline, i.e., the formation produces hydrocarbon for a shorter amount of time. Recovering a well after production decline typically involves refracturing, which can be costly and time consuming.

Traditional fracture networks may be created by utilizing some form of diversion within or among the zones of the subterranean formation. For example, a packer or bridge plug may be used between sets of access conduits to divert a treatment fluid between the access conduits. Sand may be used as a diverting agent to plug or bridge an access conduit. In another technique, balls, commonly referred to as “perf balls,” may be used to seal off individual access conduits to divert fluid, and consequently propping agents, to other access conduits. Such techniques may be only partially successful towards the creation of larger and more complex fracture networks because they only address the distribution issues at the well bore, i.e., at the access conduit and not within the highly interconnected, multi-branched complex fracture network. Particulate diverting agents may be used to specifically target, not just the primary fracture, but the branches of the primary fracture in a complex fracture network. However, particulate diverting agents may be difficult to remove completely from the subterranean formation, and may leave behind a residue which may permanently reduce the permeability of the formation.

### BRIEF DESCRIPTION OF THE DRAWINGS

These drawings illustrate certain aspects of some of the embodiments of the present method, and should not be used to limit or define the method.

FIG. 1 depicts an example of a typical fracture network.

FIG. 2 illustrates a non-limiting embodiment of the use of a hydrajetting tool in creation of an example fracture network.

FIG. 3 depicts an example of a system for delivering treatment fluids.

### DESCRIPTION OF PREFERRED EMBODIMENTS

The present method relates to fracturing treatments and, in certain embodiments, to methods of fracturing to enhance the communication between a primary fracture and the remainder of the corresponding complex fracture network. Embodiments of the present methods provide for the systematic introduction of a series of degradable particulate diverting agents that inhibit the flow of subsequent injections into a complex fracture network, thereby diverting subsequent fracturing fluids and consequently creating additional fractures in the complex fracture network as well as additional complex fracture networks. In brittle formations, like shale, a complex fracture network may comprise the primary fracture, secondary branch fractures, tertiary branch fractures, quaternary branch fractures, and the like. The complex fracture network encompasses the primary fracture and any and all branching fractures, regardless of their size, man-made or otherwise, within a subterranean formation that are in fluid communication with the access conduit and/or well bore. Embodiments of the present methods provide for treatment and diversion in the primary fracture and each of its branches. As used herein, an “access conduit” refers to a passageway that provides fluid communication between the well bore and the subterranean formation, which may include, but should not be limited to: sliding sleeves, open holes in non-cased areas, hydrajetted holes, holes in the casing, perforations, and the like. The creation of larger, more complex, and additional fracture networks maximizes the communication between the primary fracture and the rest of the complex fracture network and also the communication between the formation and the well bore. Increasing communication amongst these components will also consequently maximize hydrocarbon production therefrom, in accordance with example embodiments.

Additionally, embodiments of the methods include various particulate diverting agents that may be degradable. Degradable diverting agents decrease, and may eliminate, the need for secondary operations to restore fluid conductivity within the fracture network when production operations begin. Consequently, this reduces the environmental impact of subterranean operations. In some embodiments, this may also reduce the cost and time for fracturing operations. Further advantageously, the embodiments may utilize degradable diverting agents of different sizes, such that the consequential expansion of the complex fracture network includes all sizes of fractures and branches, including smaller fractures, micro-fractures, and any sized fracture in-between. As used herein, the term “micro-fracture” refers to a fracture or any portion of a fracture having at least one cross-sectional dimension (e.g., width, height) of less than or equal to 100 microns, thus limiting the size of particulates that can enter the micro-fracture.

Embodiments of the methods may also include a combination of variously sized propping agents introduced via a treatment fluid into a well bore penetrating a subterranean formation. In embodiments, the variously sized propping agents and the variously sized degradable particulate diverting agents may be introduced into a well bore via a plurality of treatment fluids in sequential application or injection stages. As used herein, the term “treatment” or “treating” refers to any subterranean operation that uses a fluid in conjunction with a desired function and/or for a desired purpose. The term “treatment” or “treating” does not imply any particular action by the fluid.

As used herein, a “diverting agent” refers to any material that can be used to substantially seal off a portion of a subterranean formation thereby substantially reducing, including blocking, fluid flow therethrough. The portion of the subterranean formation that may be sealed by a diverting agent may include any such portion of the subterranean formation including an access conduit, primary fracture, secondary fractures, tertiary fractures, quaternary fractures, and the like. Diverting agents used in embodiments of the methods may be degradable. Suitable degradable diverting agents may comprise gels, particulates, and/or fibers that are natural or synthetic; may be of a variety of sizes; and mixtures thereof. Non-limiting examples of suitable diverting agents are included below. It should be understood that the term “particulate,” “particle,” and derivatives thereof as used in this disclosure, include all known shapes of materials, including substantially spherical materials, low to high aspect ratio materials, fibrous materials, polygonal materials (such as cubic materials), and mixtures thereof.

As used herein, “propping agents” or “proppants” refers to any material or formulation that can be used to hold open or prop open at least a portion of a fracture network. The portion of the fracture network that may be propped open may include any such portion of the fracture network including the primary fracture, secondary fractures, tertiary fractures, quaternary fractures, and the like. It should be understood that the term “proppant” and derivatives thereof as used in this disclosure, include all known shapes of materials, including substantially spherical materials, low to high aspect ratio materials, fibrous materials, polygonal materials (such as cubic materials), and mixtures thereof.

As used herein, “complex fracture network” refers to the primary fracture, secondary branch fractures, tertiary branch fractures, quaternary branch fractures, and the like. The complex fracture network encompasses the primary fracture and any and all branching fractures, regardless of their size, man-made or otherwise, within a subterranean formation that are in fluid communication with the access conduit and/or well bore. The terms “branch” or “branches” refer to any fractures, regardless of size, that branch from another fracture or the primary fracture. The fractures of the complex fracture network may be described in different manners depending on the context. For example the fractures may be described in terms of relative size such as fracture, smaller fracture, micro-fracture, etc. It is to be understood that the description of the fractures by size in no way limits the fractures to a specific size or size range, but is merely used to distinguish and illustrate the size of a fracture in comparison to the size of another fracture. For example a “fracture” is larger than a “smaller fracture”. This statement is to be understood as merely a comparison of representative fractures in the formation and should not be taken as an indication, implied or otherwise, as a representation of any actual size, size range, scale, measurement, and so on. Alternatively, the fractures of the complex fracture network may be described by their degree of branching. The main fracture is therefore the primary fracture. Its branches are secondary fractures. Branches of the secondary fractures are tertiary fractures. Branches of the tertiary fractures are quaternary fractures and so on. Similarly, and as discussed above, this method of fracture description should also not be used to limit the fractures to a specific size or size range. Furthermore, this method of fracture description should be understood to be merely a comparison of representative fractures in the formation and should not be taken as an indication, implied or otherwise, as a representation of any actual size, size range, scale, measurement, and so on.

In some embodiments, at least one access conduit from the well bore to the subterranean formation may be created. In some embodiments, at least one access conduit from the well bore to the subterranean formation may be provided. These access conduits may be made by any means or technique known in the art including, but not limited to, hydrajetting, laser inscribing, perforating, not casing at least a portion of the well bore, and the like. Access conduits may be spaced randomly, spaced substantially equidistant from each other, clustered in groups (e.g., an access conduit cluster), or any combination thereof along the length of the well bore.

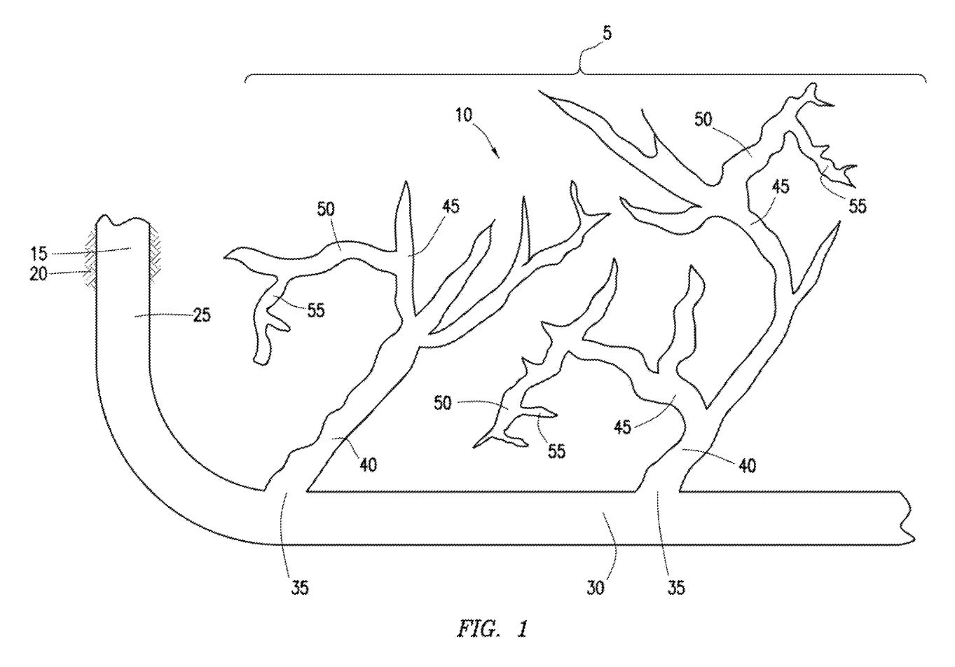

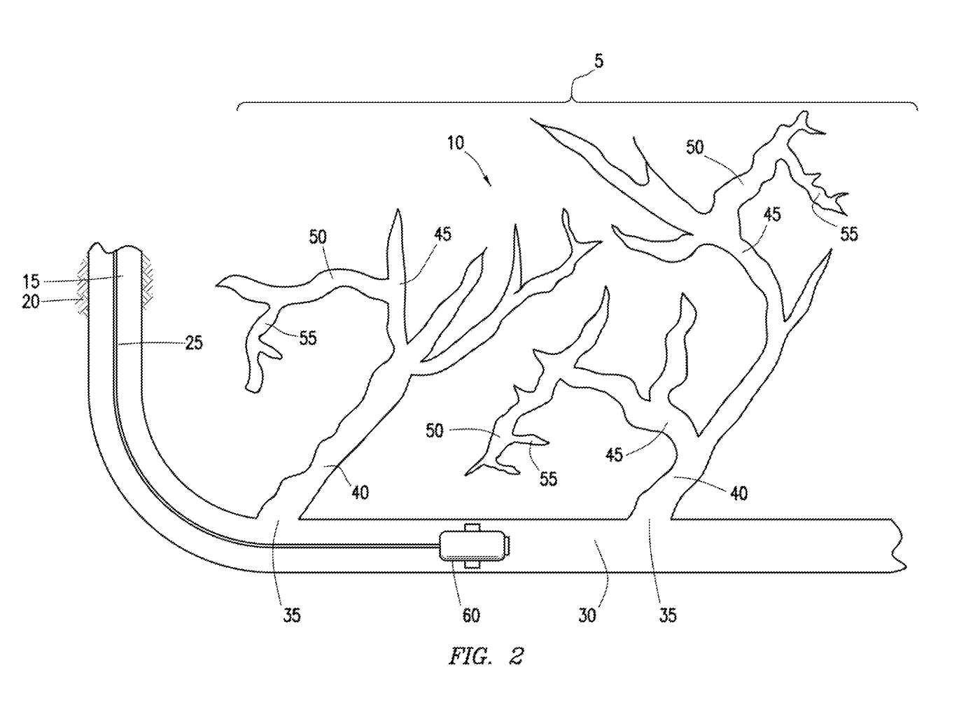

In some embodiments, a treatment fluid may be introduced into a well bore at a pressure sufficient to form at least one primary fracture extending from at least one access conduit into a subterranean formation. In some embodiments, the pressure may be sufficient to form at least one fracture branch extending from at least one primary fracture. In some embodiments, the pressure may be sufficient to form a complex fracture network. FIG. 1 illustrates a non-limiting example of a typical complex fracture network extending from a well bore into a subterranean formation. In FIG. 1, complex fracture network 5 is formed in targeted subterranean formation 10. As illustrated, well bore 15 penetrates both non-targeted subterranean formation 20 and the targeted subterranean formation 10. In the illustrated embodiments, well bore 15 comprises a vertical well bore portion 25 and a horizontal well bore portion 30. In accordance with the present embodiments, complex fracture network 5 is formed by fracturing the targeted subterranean formation 10 via access conduits 35. Complex fracture network 5 comprises primary fractures 40 which may branch into a variety of fracture branches that communicate with the primary fracture, including secondary fracture branches 45, tertiary fracture branches 50, quaternary fracture branches 55, and the like. As discussed above, complex fracture network 5 comprises the primary fracture 40, all secondary fracture branches 45, all tertiary fracture branches 50, and all quaternary fracture branches 55; regardless of size. As illustrated by FIG. 2, a hydrajetting tool 60 may be inserted into well bore 15 and positioned in such a manner to fracture targeted subterranean formation 10 with a treatment fluid. Hydrajetting tool 60 may also be used to place other treatment fluids into complex fracture network 5. It should be understood that the methods provided herein are applicable to well bores at any angle including, but not limited to, vertical wells, deviated wells, highly deviated wells, horizontal wells, and hybrid wells comprising sections of any combination of the aforementioned wells. In some embodiments, a subterranean formation and well bore may be provided with an existing fracture network.

In some methods, any single or combination of elements including propping agents and degradable particulate diverting agents may be placed via a treatment fluid into a well bore penetrating a subterranean formation. It should be noted that placing may include pumping, introducing, adding, injecting, inserting, and the like.

Some embodiments may include introducing a treatment fluid comprising nano-sized proppant and micron-sized proppant into a subterranean formation at a pressure sufficient to create a corresponding complex fracture network. In contrast to prior treatments which typically only include proppant in subsequently introduced fluids, the nano-sized and micron-sized proppant may be included in the “pad fluid” which is introduced into the formation to initiate creation of the complex fracture network. After creation of the complex fracture network, one or more additional treatment fluids comprising proppant and/or particulate diverting agents may be introduced into the complex fracture network. The additional treatment fluids may extend and further develop the complex fracture network in some embodiments.

Some embodiments may include the following steps:

(a) placing a first treatment fluid comprising nano-sized proppant and micron-sized proppant into a well bore at a pressure sufficient to create a corresponding complex fracture network extending from the well bore;

(b) placing a second treatment fluid comprising degradable nano-sized particulate diverting agents, degradable micron-sized particulate diverting agents, and macro-sized proppant into the complex fracture network;

(c) placing a third treatment fluid comprising degradable macro-sized particulate diverting agents into the complex fracture network; and

(d) optionally repeating steps a, b, and c for one or more intervals as desired.

Without being limited by theory, in step (a), it is believed that the nano-sized proppant may be placed into the micro-fractures in the complex network (e.g., quaternary fracture branches 55 of complex fracture network 5 on FIG. 1), which relative to the size of the other fractures, would be smaller. Additionally, the micron-sized proppant may also be placed into the micro-fractures. These micro-fractures may have a size that only nano- and micron-sized proppant can enter. In other words, the macro-sized proppant may be too large to enter the micro-fractures. In step (b), it is believed that a combination of degradable micron-sized particulate diverting agents and macro-size proppant would generally be placed into the complex fracture network including the primary fractures and their corresponding fracture branches (e.g., primary fractures 40 and second branches 45 of complex fracture network 5 on FIG. 1). This combination of particulates may cause bridging at the entrances of micro-fractures to open up new micro-fractures. Optionally, an additional treatment fluid may be introduced into the complex fracture network between steps (b) and (c), which may comprise one or more of nano-sized proppant, micron-sized proppant, or macro-sized proppant. The nano- and micron-sized proppant included in this additional treatment fluid may enter the newly created micro-fracture. By placing the macro-sized proppant and the degradable macro-sized particulate diverting agents into the primary fractures and their corresponding branches in steps (b) and (c), it is believed that subsequently introduced fluids may be diverted to form new fracture branches and new complex fracture networks.

As described above, a degradable particulate diverting agent may substantially inhibit fluid flow through a complex fracture network, e.g., through any such fractures and/or a branches so as to divert fluid flow to other non-inhibited fractures in the complex fracture network. The use of various sizes of proppant and degradable particulate diverting agents in the embodiments enables the temporary shut off of flow into more fractures and branches of the complex fracture network than the use of a single sized proppant and degradable particulate diverting agent. The fractures and/or branches of the complex fracture network may comprise many different sizes both in depth and diameter. Furthermore, the sizes of the fractures and/or branches may be dynamic and therefore require differing sizes of proppant and degradable diverting particulate agents throughout the body of the fracture. As more fractures and branches of the complex fracture network are inhibited, the amount of fracturing fluid diverted will increase. As the diversion of the fracturing fluid is increased, the number of new fractures created within a complex fracture network will be greater. In addition, new complex fracture networks may also be formed. Also, and as discussed above, the description of the fractures or branches is not reflective of size, but is a description of the relationship of one branch or fracture to another. The fractures and branches can vary in size. For example a tertiary branch of one complex fracture network may have an opening diameter greater than a secondary branch of another complex fracture network. Moreover, the naming convention of the fractures or branches should remain constant. A secondary branch will always be a secondary branch because it will always branch from the primary fracture. However, the diameter of the opening of a fracture or branch may vary. This variation may be due to subsequent fracturing intervals, hydrocarbon flow, natural shifts or movements in the subterranean formation, and the like. Therefore, a specific sized proppant or particulate diverting agent that was too large to enter a branch or fracture, may be able to enter a branch or fracture at a different time should the opening of the branch or fracture change.

In some embodiments, the selection of the particulate diverting agent is a function of the size of the proppant placed in the well bore by the treatment fluid of the previous process step. The size of the particulate diverting agent is therefore relative to the size of the proppant placed prior to the particulate diverting agent; for example, the size range of a particulate diverting agent used in step c will be smaller than or equal to the size range of the proppant used in step b.

In some embodiments, the methods optionally may comprise monitoring the flow of one or more treatment fluids in at least a portion of the subterranean formation during all or part of an example method. Monitoring may, for example, determine whether a proppant or degradable particulate diverting agent has been placed appropriately within the complex fracture network, determine the presence or absence of a proppant or degradable particulate diverting agent in the complex fracture network, and/or determine whether the proppant or degradable particulate diverting agents are performing their intended functions. Monitoring may be accomplished by any technique or combination of techniques known in the art. In certain embodiments, this may be accomplished by monitoring the fluid pressure at the surface of a well bore penetrating the subterranean formation where fluids are introduced. For example, if the fluid pressure at the surface increases, this may indicate that the fluid is being diverted within the fracture network. Additionally, a pressure decrease or substantially steady-state pressure may indicate a portion of the complex fracture network is being enhanced. Pressure monitoring techniques may include various logging techniques and/or computerized fluid tracking techniques known in the art that are capable of monitoring fluid flow. Examples of commercially available services involving surface fluid pressure sensing that may be suitable for use in embodiments of the present methods include those available under the tradename EZ-GAUGE™ available from Halliburton Energy Services, Inc., Duncan, Okla.

In some embodiments, a hydrajetting tool (e.g., hydrajetting tool 60 on FIG. 2) may be used to place one or more of the treatment fluids. The hydrajetting tool must have at least one fluid jet forming nozzle in the well bore adjacent the formation to be fractured or the complex fracture network to be enhanced. The hydrajetting tool may then jet fluid through the nozzle against the formation at a pressure sufficient to form a cavity therein and fracture the formation or extend and expand the complex fracture network already present. A hydrajetting tool may also be used to create one or more perforations in the casing if present. Certain hydrajetting techniques that may be suitable for use in embodiments may include commercially-available hydrajetting services such as those known under the tradename SURGIFRAC™ available from Halliburton Energy Services, Inc., Duncan, Okla.

Examples of suitable treatment fluids that may be used in accordance with present embodiments include, for example, aqueous fluids, non-aqueous fluids, slickwater fluids, aqueous gels, viscoelastic surfactant gels, foamed gels, and emulsions, for example. Examples of suitable aqueous fluids include fresh water, saltwater, brine, seawater, and/or any other aqueous fluid that does not undesirably interact with the other components used in accordance with present embodiments or with the subterranean formation. Examples of suitable non-aqueous fluids include organic liquids, such as hydrocarbons (e.g., kerosene, xylene, toluene, or diesel), oils (e.g., mineral oils or synthetic oils), esters, and the like. Suitable slickwater fluids are generally prepared by addition of small concentrations of polymers to water to produce what is known in the art as “slick-water.” Suitable aqueous gels are generally comprised of an aqueous fluid and one or more gelling agents. Suitable emulsions may be comprised of two immiscible liquids such as an aqueous fluid or gelled fluid and a hydrocarbon. Foams may be created by the addition of a gas, such as carbon dioxide or nitrogen. In certain embodiments, the treatment fluids are aqueous gels comprised of an aqueous fluid, a gelling agent for gelling the aqueous fluid and increasing its viscosity, and, optionally, a crosslinking agent for crosslinking the gel and further increasing the viscosity of the fluid. The increased viscosity of the gelled, or gelled and crosslinked, treatment fluid, inter alia, reduces fluid loss and allows the treatment fluid to transport significant quantities of suspended particulates. The density of the treatment fluid can be increased to provide additional particle transport and suspension in some embodiments. In certain embodiments, aqueous gels which may be crosslinked can be used as the second treatment fluid and/or the third treatment fluid.

In certain embodiments a friction reducer may be used. In particular embodiments, the friction reducer may be included in the first treatment fluid to form a slickwater fluid, for example. In certain embodiments, the friction reducing polymer may be a synthetic polymer. Additionally, for example, the friction reducing polymer may be an anionic polymer or a cationic polymer, in accordance with particular embodiments. By way of example, suitable synthetic polymers may comprise any of a variety of monomeric units, including acrylamide, acrylic acid, 2-acrylamido-2-methylpropane sulfonic acid, N,N-dimethylacrylamide, vinyl sulfonic acid, N-vinyl acetamide, N-vinyl formamide, itaconic acid, methacrylic acid, acrylic acid esters, methacrylic acid esters and combinations thereof.

Suitable friction reducing polymers may be in an acid form or in a salt form. As will be appreciated, a variety of salts may be prepared, for example, by neutralizing the acid form of the acrylic acid monomer or the 2-acrylamido-2-methylpropane sulfonic acid monomer. In addition, the acid form of the polymer may be neutralized by ions present in the treatment fluid. Indeed, as used herein, the term “polymer” in the context of a friction reducing polymer, is intended to refer to the acid form of the friction reducing polymer, as well as its various salts.

The friction reducing polymer should be included in the treatment fluids, for example, in an amount equal to or less than 0.2% by weight of the water present in the treatment fluid. In some embodiments, the friction reducing polymers may be included in embodiments of the treatment fluids in an amount sufficient to reduce friction without gel formation upon mixing. By way of example, the treatment fluid comprising the friction reducing polymer may not exhibit an apparent yield point. While the addition of a friction reducing polymer may minimally increase the viscosity of the treatment fluids, the polymers are generally not included in the example treatment fluids in an amount sufficient to substantially increase the viscosity. For example, if proppant is included in the treatments fluids, velocity rather than fluid viscosity generally may be relied on for proppant transport. In some embodiments, the friction reducing polymer may be present in an amount in the range of from about 0.01% to about 0.15% by weight of the water. In some embodiments, the friction reducing polymer may be present in an amount in the range of from about 0.025% to about 0.1% by weight of the water.

In certain embodiments, the propping agents may comprise a plurality of proppant particulates. Proppant particulates suitable for use in particular embodiments may comprise any material suitable for use in subterranean operations. The nano-sized proppant, micron-sized proppant, and macro-sized proppant may individually comprise a variety of materials, including, but not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof.

As previously described, the propping agents used in accordance with example embodiments may include nano-sized proppant, micron-sized proppant, and macro-sized proppant. The mean particle size for the nano-sized proppant generally may range from about 5 nm to about 500 nm, including every number in-between. For example, the size of the nano-sized proppant may be about 5 nm, 10 nm, 15 nm to about 40 nm, 45 nm, 50 nm, etc. The mean particle size for the micron-sized proppant generally may range from about 0.5 μm to about 150 μm. For example, the size of the micron-sized proppant may be about 0.5 μm, 0.1 μm, 1 μm to about 10 μm, 100 μm, 150 μm, etc. The mean particle size for the macro-sized proppant generally may range from about 150 μm to about 1000 μm. For example, the size of the macro-sized proppant may be about 150 μm, 250 μm, 350 μm to about 800 μm, 900 μm, 1000 μm, etc. The proppant may be any known shape of material, including substantially spherical materials, fibrous materials, polygonal materials (such as cubic materials), and combinations thereof.

In some embodiments, the nano- and micron-sized proppant may be carried by the first treatment fluid. In further embodiments, the nano- and/or micron-sized proppant may then enter the smaller and micro-fractures as soon as they are generated. In embodiments, the concentrations of the nano- and micron-sized proppant in the first treatment fluid may individually range from about 0.001 pounds per gallon to about 1 pound per gallon (ppg), and in further embodiments from about 0.05 ppg to about 0.2 ppg. These ranges encompass every number in between, for example the concentration may range between about ppg 0.01 to about 0.1 ppg. One of ordinary skill in the art with the benefit of this disclosure should be able to select an appropriate amount of the nano- and micron-sized proppant to use for a particular application.

In embodiments, the macro-sized proppant may be carried by the second treatment fluid. In further embodiments, the macro-sized proppant may enter the primary fractures and their corresponding branches in the complex fracture network. In embodiments, the concentrations of the macro-sized proppant may range from about 0.1 ppg to about 10 ppg and in further embodiments from about 0.2 ppg to about 6 ppg. These ranges encompass every number in between, for example the concentration may range between about 0.5 ppg to about 4 ppg. One of ordinary skill in the art with the benefit of this disclosure should be able to select an appropriate amount of the nano- and micron-sized proppant to use for a particular application.

Suitable degradable particulate diverting agents (of any size) for use in particular embodiments may be any suitable degradable diverting agent including, but not limited to, any lost circulation materials, bridging agent, diverting agent, plugging agent, or the like suitable for use in a subterranean formation. Suitable diverting agents may comprise gels, particles, and/or fibers that are natural or synthetic; and mixtures thereof. Non-limiting examples of commercially available diverting agents include BIOVERT™ degradable diverting agents (available from Halliburton Energy Services, Inc.) such as BIOVERT™ NWB and BIOVERT™ CF degradable diverting agents.

As previously described, the degradable particulate diverting agents may be nano-sized, micron-sized, and/or macro-sized, for example. In some embodiments, particulates of the nano-sized degradable diverting agent may have a mean particle size in the range from about 5 nm to about 500 nm. For example, the size of the nano-sized degradable diverting agent may be about 5 nm, 10 nm, 15 nm to about 40 nm, 45 nm, 50 nm, etc. The mean particle size for the micron-sized degradable diverting agent generally may range from about 0.5 μm to about 150 μm. For example, the size of the micron-sized proppant may be about 0.5 μm, 0.10 μm, 1 μm to about 10 μm, 100 μm, 150 μm, etc. The mean particle size for the macro-sized degradable diverting agent generally may range from about 150 μm to about 1000 μm. For example, the size of the macro-sized degradable diverting agent may be about 150 μm, 250 μm, 350 μm to about 800 μm, 900 μm, 1000 μm, etc.

In some embodiments, the nano- and micron-sized degradable diverting agents may be carried by the second treatment fluid. In further embodiments, the nano- and/or micron-sized diverting agents may enter the primary fractures and their corresponding branches in the complex fracture network. In embodiments, the concentrations of the nano- and micron-sized diverting agents in the second treatment fluid may individually range from about 0.001 ppg to about 1 ppg, and in further embodiments from about 0.05 ppg to about 0.2 ppg. These ranges encompass every number in between, for example the concentration may range between about ppg 0.01 to about 0.1 ppg. One of ordinary skill in the art with the benefit of this disclosure should be able to select an appropriate amount of the nano- and micron-sized diverting agents to use for a particular application.

In embodiments, the macro-sized diverting agents may be carried by the third treatment fluid. In embodiments, the concentrations of the macro-sized diverting agents may range from about 0.1 ppg to about 10 ppg and in further embodiments from about 0.2 ppg to about 6 ppg. These ranges encompass every number in between, for example the concentration may range between about 0.5 ppg to about 4 ppg. One of ordinary skill in the art with the benefit of this disclosure should be able to select an appropriate amount of the nano- and micron-sized diverting agents to use for a particular application.

In embodiments, a particulate diverting agent may be at least partially degradable. Non-limiting examples of suitable degradable materials that may be used in particular embodiments include, but are not limited to, degradable polymers (crosslinked or otherwise), dehydrated compounds, and/or mixtures of the two. The terms “polymer” or “polymers” as used herein do not imply any particular degree of polymerization; for instance, oligomers are encompassed within this definition. A polymer is considered to be “degradable” herein if it is capable of undergoing an irreversible degradation when used in subterranean applications, e.g., in a well bore. The term “irreversible” as used herein means that the degradable material should degrade in situ (e.g., within a well bore) but should not recrystallize or reconsolidate in situ after degradation (e.g., in a well bore).

Degradable materials may include, but not be limited to, dissolvable materials, materials that deform or melt upon heating such as thermoplastic materials, hydrolytically degradable materials, materials degradable by exposure to radiation, materials reactive to acidic fluids, or any combination thereof. In some embodiments, degradable materials may be degraded by temperature, presence of moisture, oxygen, microorganisms, enzymes, pH, free radicals, and the like. In some embodiments, degradation may be initiated in a subsequent treatment fluid introduced into the subterranean formation at some time when diverting is no longer necessary. In some embodiments, degradation may be initiated by a delayed-release acid, such as an acid-releasing degradable material or an encapsulated acid, and this may be included in the treatment fluid comprising the degradable material so as to reduce the pH of the treatment fluid at a desired time, for example, after introduction of the treatment fluid into the subterranean formation.

In choosing the appropriate degradable material, one should consider the degradation products that will result. Also, these degradation products should not adversely affect other operations or components. For example, a boric acid derivative may not be included as a degradable material in the example treatment fluids where such fluids use guar as the viscosifier, because boric acid and guar are generally incompatible. One of ordinary skill in the art, with the benefit of this disclosure, will be able to recognize when potential components of an example treatment fluid would be incompatible or would produce degradation products that would adversely affect other operations or components.

The degradability of a degradable polymer often depends, at least in part, on its backbone structure. For instance, the presence of hydrolyzable and/or oxidizable linkages in the backbone often yields a material that will degrade as described herein. The rates at which such polymers degrade are dependent on the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades, e.g., temperature, presence of moisture, oxygen, microorganisms, enzymes, pH, and the like.

Suitable examples of degradable polymers for a particulate diverting agent include, but are not limited to: polysaccharides such as cellulose; chitin; chitosan; aliphatic polyesters; and proteins. Such suitable polymers may be prepared by polycondensation reactions, ring-opening polymerizations, free radical polymerizations, anionic polymerizations, carbocationic polymerizations, coordinative ring-opening polymerizations, as well as by any other suitable process. Examples of specific degradable polymers that may be used in conjunction with the example methods include, but are not limited to, aliphatic poly(esters); poly(lactides); poly(glycolides); poly(ε-caprolactones); poly(hydroxyester ethers); poly(hydroxybutyrates); poly(anhydrides); polycarbonates; poly(orthoesters); poly(aminoacids); poly(ethyleneoxides); poly(phosphazenes); poly(etheresters), polyester amides, polyamides, copolymers, terpolymers, etc.; and/or blends of any of these degradable polymers, and derivatives of these degradable polymers. As referred to herein, the term “derivative” is defined herein to include any compound that is made from one of the listed compounds, for example, by replacing one atom in the base compound with another atom or group of atoms. Of these suitable polymers, aliphatic polyesters such as poly(lactic acid), poly(anhydrides), poly(orthoesters), and poly(lactide)-co-poly(glycolide) copolymers are preferred. Poly(lactic acid) is especially preferred. Other degradable polymers that are subject to hydrolytic degradation also may be suitable. One's choice may depend on the particular application and the conditions involved. Other guidelines to consider include the degradation products that result, the time required for the requisite degree of degradation, and the desired result of the degradation (e.g., voids).

Aliphatic polyesters degrade chemically, inter alia, by hydrolytic cleavage. Hydrolysis can be catalyzed by either acids or bases. Generally, during the hydrolysis, carboxylic end groups may be formed during chain scission, which may enhance the rate of further hydrolysis. This mechanism is known in the art as “autocatalysis,” and is thought to make polyester matrices more bulk-eroding.

In certain embodiments wherein an aliphatic polyester is used, the aliphatic polyester may be poly(lactide). Poly(lactide) is synthesized either from lactic acid by a condensation reaction or, more commonly, by ring-opening polymerization of cyclic lactide monomer. Since both lactic acid and lactide can achieve the same repeating unit, the general term poly(lactic acid) as used herein refers to writ of formula 1 without any limitation as to how the polymer was made (e.g., from lactides, lactic acid, or oligomers), and without reference to the degree of polymerization or level of plasticization. The lactide monomer exists generally in three different forms: two stereoisomers (L- and D-lactide) and racemic D,L-lactide (meso-lactide).

The chirality of the lactide units provides a means to adjust, inter alia, degradation rates, as well as physical and mechanical properties. Poly(L-lactide), for instance, is a semicrystalline polymer with a relatively slow hydrolysis rate. This could be desirable in some embodiments in which a slower degradation of the degradable material is desired. Poly(D,L-lactide) may be a more amorphous polymer with a resultant faster hydrolysis rate. This may be suitable for other applications in which a more rapid degradation may be appropriate. The stereoisomers of lactic acid may be used individually, or may be combined in accordance with the some embodiments. Additionally, they may be copolymerized with, for example, glycolide or other monomers like ε-caprolactone, 1,5-dioxepan-2-one, trimethylene carbonate, or other suitable monomers to obtain polymers with different properties or degradation times. Additionally, the lactic acid stereoisomers can be modified by blending high and low molecular weight polylactide or by blending polylactide with other polyesters. In embodiments wherein polylactide is used as the degradable material, certain preferred embodiments employ a mixture of the D and L stereoisomers, designed so as to provide a desired degradation time and/or rate. Examples of suitable sources of degradable material are commercially available 6250D™ (poly(lactic acid), available from Cargill Dow) and 5639A™ (poly(lactic acid), available from Cargill Dow).

Polyanhydrides are another type of degradable polymer that may be suitable for embodiments. Polyanhydride hydrolysis proceeds, inter alia, via free carboxylic acid chain-ends to yield carboxylic acids as final degradation products. Their erosion time can be varied over a broad range of changes in the polymer backbone. Examples of suitable polyanhydrides include poly(adipicanhydride), poly(subericanhydride), poly(sebacicanhydride), and poly(dodecanedioicanhydride). Other suitable examples include, but are not limited to, poly(maleicanhydride) and poly(benzoicanhydride).

The physical properties of degradable polymers may depend on several factors including, but not limited to, the composition of the repeat units, flexibility of the chain, presence of polar groups, molecular mass, degree of branching, crystallinity, and orientation. For example, short chain branches may reduce the degree of crystallinity of polymers while long chain branches may lower the melt viscosity and may impart, inter alia, extensional viscosity with tension-stiffening behavior. The properties of the material utilized further may be tailored by blending, and copolymerizing it with another polymer, or by a change in the macromolecular architecture (e.g., hyper-branched polymers, star-shaped, or dendrimers, and the like). The properties of any such suitable degradable polymers (e.g., hydrophobicity, hydrophilicity, rate of degradation, and the like) can be tailored by introducing select functional groups along the polymer chains. For example, poly(phenyllactide) will degrade at about one-fifth of the rate of racemic poly(lactide) at a pH of 7.4 at 55° C. One of ordinary skill in the art, with the benefit of this disclosure, will be able to determine the appropriate functional groups to introduce to the polymer chains to achieve the desired physical properties of the degradable polymers.

Suitable dehydrated compounds for use as degradable particulate diverting agents may degrade over time as they are rehydrated. For example, a particulate solid anhydrous borate material that degrades over time may be suitable for embodiments. Specific examples of particulate anhydrous borate materials that may be used include, but are not limited to, anhydrous sodium tetraborate (also known as anhydrous borax) and anhydrous boric acid.

Whichever degradable material is used in accordance with example embodiments, the degradable material may have any shape, including, but not limited to, particles having the physical shape of platelets, shavings, flakes, ribbons, rods, strips, spheroids, toroids, pellets, tablets, or any other physical shape. In certain embodiments, the degradable material used may comprise a mixture of fibers and spherical particles. One of ordinary skill in the art, with the benefit of this disclosure, will recognize the specific degradable material that may be used in accordance with particular embodiments, and the preferred size and shape for a given application.

In choosing the appropriate degradable material, one should consider the degradation products that will result, and choose a degradable material that will not yield degradation products that would adversely affect other operations or components utilized in that particular application. The choice of degradable material also may depend, at least in part, on the conditions of the well (e.g., well bore temperature). For instance, lactides have been found to be suitable for lower temperature wells, including those within the range of 60° F. to 150° F., and polylactides have been found to be suitable for well bore temperatures above this range.

In certain embodiments, the degradation of the degradable material could result in a final degradation product having the potential to affect the pH of the treatment fluids utilized in the example methods. For example, in certain embodiments wherein the degradable material is poly(lactic acid), the degradation of the poly(lactic acid) to produce lactic acid may alter the pH of the treatment fluids. In certain embodiments, a buffer compound may be included within the treatment fluids utilized in the example methods in an amount sufficient to neutralize the final degradation product. Examples of suitable buffer compounds include, but are not limited to, calcium carbonate, magnesium oxide, ammonium acetate, and the like. One of ordinary skill in the art, with the benefit of this disclosure, will be able to identify the proper type and concentration of a buffer compound to include in the treatment fluids for a particular application. An example of a suitable buffer compound comprises commercially available BA-20™ buffering agent (available from Halliburton Energy Services, Inc.).

In some embodiments, a treatment fluid for use in particular embodiments may further comprise an additive including, but not limited to, a salt; a weighting agent; an inert solid; a fluid loss control agent; an emulsifier; a dispersion aid; a corrosion inhibitor; an emulsion thinner; an emulsion thickener; a viscosifying agent; a high-pressure, high-temperature emulsifier-filtration control agent; a surfactant; a particulate; a lost circulation material; a foaming agent; a gas; a pH control additive; a breaker; a biocide; a crosslinker; a stabilizer; a chelating agent; a scale inhibitor; a mutual solvent; an oxidizer; a reducer; a friction reducer; a clay stabilizing agent, a consolidating agent; a complexing agent; and any combination thereof.

In some embodiments, the amount of an element of a treatment fluid may vary during a step. By way of example, changing the amount of an element in a treatment fluid may be an increase or decrease as a stepwise change, a gradient change, or any combination thereof. In some embodiments where multiple elements are introduced simultaneously, the amount of one or more elements may change during the step. In some embodiments, the amount of element(s) may stay constant while the amount of other additive(s), including those described above, are changed. In some embodiments, both the amount of element(s) and additive(s) may change within a step. In some embodiments, an element may be introduced into the well bore after the well bore pressure increases and begins to level off. In some embodiments, an element may be introduced into the well bore during substantially steady-state well bore pressure. By way of a non-limiting example, propping agents may be introduced in a periodic fashion or the propping agents may be introduced continuously and increased step-wise over time.

The embodiments described herein may be used in any subterranean formation capable of being fractured. Formations where the present methods may be most advantageous include, but are not limited to, formations with at least a portion of the formation characterized by very low permeability; very low formation pore throat size; high closure pressures; high brittleness index; and any combination thereof.

In some embodiments, at least a portion of a subterranean formation may have a permeability ranging from a lower limit of about 0.1 nano Darcy (nD), 1 nD, 10 nD, 25 nD, 50 nD, 100 nD, or 500 nD to an upper limit of about 10 mD, 1 mD, 500 microD, 100 microD, 10 microD, or 500 nD, and wherein the permeability may range from any lower limit to any upper limit and encompass any subset therebetween.

In some embodiments, at least a portion of a subterranean formation may have an average formation pore throat size ranging from a lower limit of about 0.005 microns, 0.01 microns, 0.05 microns, 0.1 microns, 0.25 microns, or 0.5 microns to an upper limit of about 2.0 microns, 1.5 microns, 1.0 microns, or 0.5 microns, and wherein the average formation pore throat size may range from any lower limit to any upper limit and encompass any subset therebetween.

In some embodiments, at least a portion of a subterranean formation may have a closure pressure greater than about 500 psi to an unlimited upper limit. While the closure pressure upper limit is believed to be unlimited, formations where the methods of the example embodiments may be applicable include formations with a closure pressure ranging from a lower limit of about 500 psi, 1000 psi, 1500 psi, or 2500 psi to an upper limit of about 20,000 psi, 15,000 psi, 10,000 psi, 8500 psi, or 5000 psi, and wherein the closure pressure may range from any lower limit to any upper limit and encompass any subset therebetween.

In some embodiments, at least a portion of a subterranean formation may have a brittleness index ranging from a lower limit of about 5, 10, 20, 30, 40, or 50 to an upper limit of about 150, 125, 100, or 75, and wherein the brittleness index may range from any lower limit to any upper limit and encompass any subset therebetween. Brittleness is a composite of Poisson's ratio and Young's modulus.

In certain embodiments, all or part of a well bore penetrating the subterranean formation may include casing pipes or strings placed in the well bore (a “cased hole” or a “partially cased hole”), among other purposes, to facilitate production of fluids out of the formation and through the well bore to the surface. In other embodiments, the well bore may be an “open hole” that has no casing.

In various embodiments, systems configured for delivering the treatment fluids described herein to a downhole location are described. In various embodiments, the systems can comprise a pump fluidly coupled to a tubular, the tubular containing treatment fluids comprising at least one of nano-sized proppant, micron-sized proppant, macro-sized proppant, nano-sized degradable particulate diverting agent, micron-sized degradable particulate diverting agent, and/or macro-sized degradable particulate diverting agent.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluids to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluids to the high pressure pump. In such embodiments, the low pressure pump may “step up” the pressure of the treatment fluids before it reaches the high pressure pump.

In some embodiments, the systems described herein can further comprise a mixing tank that is upstream of the pump and in which the treatment fluids are individually formulated. In various embodiments, the pump (e.g., a low pressure pump, a high pressure pump, or a combination thereof) may convey the treatment fluids from the mixing tank or other source of the treatment fluids to the tubular. In other embodiments, however, the treatment fluids can be formulated offsite and transported to a worksite, in which case the treatment fluids may be introduced to the tubular via the pump directly from its shipping container (e.g., a truck, a railcar, a barge, or the like) or from a transport pipeline. In either case, the treatment fluids may be drawn into the pump, elevated to an appropriate pressure, and then introduced into the tubular for delivery downhole.

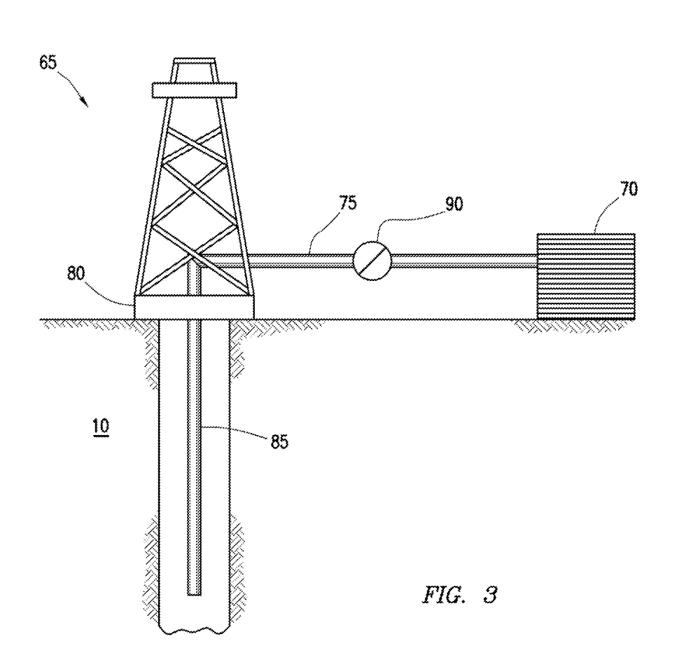

FIG. 3 shows an illustrative schematic of a system that can deliver example treatment fluids to a downhole location, according to one or more embodiments. It should be noted that while FIG. 3 generally depicts a land-based system, it is to be recognized that like systems may be operated in subsea locations as well. As depicted in FIG. 3, system 65 may include mixing tank 70, in which a treatment fluid of the present embodiments may be formulated. The treatment fluid may be conveyed via line 75 to wellhead 80, where the treatment fluid enters tubular 85, tubular 85 extending from wellhead 80 into targeted subterranean formation 10. Upon being ejected from tubular 85, the treatment fluid may subsequently penetrate into targeted subterranean formation 10. Pump 90 may be configured to raise the pressure of the treatment fluid to a desired degree before its introduction into tubular 85. It is to be recognized that system 65 is merely exemplary in nature and various additional components may be present that have not necessarily been depicted in FIG. 3 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 3, the treatment fluid may, in some embodiments, flow back to wellhead 80 and exit targeted subterranean formation 10. In some embodiments, the treatment fluid that has flowed back to wellhead 80 may subsequently be recovered and recirculated to targeted subterranean formation 10.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method of fracturing a subterranean formation comprising:
placing a treatment fluid into the subterranean formation at a pressure sufficient to create a complex fracture network in the subterranean formation, wherein the treatment fluid comprises nano-sized proppant and micron-sized proppant; and
placing one or more additional treatment fluids comprising particulate materials into the complex fracture network.

2. The method of claim 1 wherein the treatment fluid is placed into the subterranean formation at about 1000 psi or greater using a high pressure pump.

3. The method of claim 1 wherein the treatment fluid further comprises a friction reducing polymer comprising at least one monomeric unit selected from the group consisting of acrylamide, acrylic acid, 2-acrylamido-2-methylpropane sulfonic acid, N,N-dimethylacrylamide, vinyl sulfonic acid, N-vinyl acetamide, N-vinyl formamide, itaconic acid, a methacrylic acid, an acrylic acid ester, a methacrylic acid ester, and any combination thereof.

4. The method of claim 1 wherein the treatment fluid further comprises a friction reducer in an amount equal to or less than 0.2% by weight of the treatment fluid.

5. The method of claim 1 wherein the nano-sized proppant, the micron-sized proppant, and the macro-sized proppant each individually comprise at least one material selected from the group consisting of sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, silica, alumina, fumed carbon, carbon black, graphite, mica, titanium dioxide, meta-silicate, calcium silicate, kaolin, talc, zirconia, boron, fly ash, hollow glass microspheres, ceramic microspheres, solid glass, and any combination thereof.

6. The method of claim 1 wherein the mean particle size of the nano-sized proppant is between about 5 nm to about 50 nm, and wherein the mean particle size of the micron-sized proppant is between about 0.5 μm to about 150 μm.

7. The method of claim 1 wherein the nano-sized proppant and the micron-sized proppant are individually present in the treatment fluid in an amount between about 0.001 ppg to about 1 ppg by volume of the treatment fluid.

8. A method of fracturing a subterranean formation comprising:
placing a first treatment fluid into the subterranean formation at a pressure sufficient to create a complex fracture network in the subterranean formation, wherein the treatment fluid comprises nano-sized proppant and micron-sized proppant;
placing a second treatment fluid into the complex fracture network, wherein the second treatment fluid comprises a degradable nano-sized particulate diverting agent, a degradable micron-sized particulate diverting agent, and macro-sized proppant; and
placing a third treatment fluid into the complex fracture network, wherein the third treatment fluid comprises a degradable macro-sized particulate diverting agent.

9. The method of claim 8 further comprising introducing an additional treatment fluid into the complex fracture network between the second treatment fluid and the third treatment fluid, wherein the additional treatment fluid comprises nano-sized proppant, micron-sized proppant, and macro-sized proppant.

10. The method of claim 8 wherein at least one of the first treatment fluid, the second treatment fluid, or the third treatment fluid is placed at a pressure of about 1000 psi or greater using a high pressure pump.

11. The method of claim 8 wherein at least one of the first treatment fluid, the second treatment fluid, or the third treatment fluid is placed using a hydrajetting tool.

12. The method of claim 8 wherein the treatment fluid further comprising a friction reducing polymer in an amount equal to or less than 0.2% by weight of the treatment fluid, wherein the friction reducing polymer comprises at least one monomeric unit selected from the group consisting of acrylamide, acrylic acid, 2-acrylamido-2-methylpropane sulfonic acid, N,N-dimethylacrylamide, vinyl sulfonic acid, N-vinyl acetamide, N-vinyl formamide, itaconic acid, a methacrylic acid, an acrylic acid esters, a methacrylic acid ester, and any combination thereof.

13. The method of claim 8 wherein the nano-sized proppant, the micron-sized proppant, and the macro-sized proppant each individually comprise at least one material selected from the group consisting of sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, silica, alumina, fumed carbon, carbon black, graphite, mica, titanium dioxide, meta-silicate, calcium silicate, kaolin, talc, zirconia, boron, fly ash, hollow glass microspheres, ceramic microspheres, solid glass, and any combinations thereof.

14. The method of claim 8 wherein the mean particle size of the nano-sized proppant is between about 5 nm to about 50 nm; wherein the mean particle size 0f the micron-sized proppant is between about 0.5 μm to about 150 μm; wherein the mean particle size of the macro-sized proppant is between about 150 μm to about 1000 μm; wherein the mean particle size of the nano-sized degradable particulate diverting agent is between about 5 nm to about 50 nm; wherein the mean particle size of the micron-sized degradable particulate diverting agent is between about 0.5 μm to about 150 μm; and wherein the mean particle size of the macro-sized degradable particulate diverting agent is between about 150 μm to about 1000 μm.

15. The method of claim 8 wherein the nano-sized proppant and the micron-sized proppant are individually present in the first treatment fluid in an amount between about 0.001 ppg to about 1 ppg by volume of the first treatment fluid, wherein the macro-sized proppant is individually present in the second treatment fluid in an amount between about 0.1 ppg to about 10 ppg by volume of the second treatment fluid, wherein the nano-sized degradable particulate diverting agent and the micron-sized degradable particulate diverting agent are individually present in the second treatment fluid in an amount between about 0.001 ppg to about 1 ppg by volume of the second treatment fluid, and wherein the macro-sized degradable particulate diverting agent is individually present in the third treatment fluid in an amount between about 0.1 ppg to about 10 ppg by volume of the third treatment fluid.

16. The method of claim 8 wherein the nano-sized degradable particulate diverting agent, the micron-sized degradable particulate diverting agent, and the macro-sized degradable particulate diverting agent each individually comprise at least one degradable polymer selected from the group consisting of aliphatic poly(esters), poly(lactides); poly(glycolides); poly(ε-caprolactones); poly(hydroxyesterethers); poly(hydroxybutyrates); poly(anhydrides); polycarbonates; poly(orthoesters); poly(aminoacids); poly(ethylene oxides); poly(phosphazenes); poly(etheresters); poly(esteramides); poly(amides); and any copolymers, terpolymers, and combinations thereof.

17. A system for fracturing a subterranean formation comprising:
a first treatment fluid for creation of a complex fracture network in the subterranean formation, wherein the first treatment fluid comprises nano-sized proppant and micron-sized proppant;
a second treatment fluid for introduction into the complex fracture network, wherein the second treatment fluid comprises a degradable nano-sized particulate diverting agent, a degradable micron-sized particulate diverting agent; and macro-sized proppant; and
a third treatment fluid for introduction into the complex fracture network, wherein the third treatment fluid comprises a degradable macro-sized particulate diverting agent.

18. The system of claim 17 further comprising an additional treatment fluid for introducing into the complex fracture network, wherein the additional treatment fluid comprises nano-sized proppant, micron-sized proppant, and macro-sized proppant.

19. The system of claim 17 further comprising mixing equipment for individually mixing the first treatment fluid, the second treatment fluid, and the third treatment fluid; and
pumping equipment for delivering the first treatment fluid, the second treatment fluid, and the third treatment fluid into a well bore.

20. The system of claim 17 further comprising hydrajetting equipment for placing at least one of the first treatment fluid, the second treatment fluid, or the third treatment fluid into the subterranean formation.
